(19) United States
(12) Patent Application Publication
(10) Pub. No.: US 2026/0333033 A1
(43) Pub. Date: Oct. 22, 2026

(54) SYSTEM AND METHOD OF EXCHANGING DATA BETWEEN TWO WIRELESS DEVICES

(71) Applicant: Renesas Design Austria GmbH, Graz (AT)

(72) Inventors: David RENNO, Graz (AT); Wei TONG, Graz (AT); Benjamin Frederic Bertrand LAURET, Graz (AT)

(73) Assignee: Renesas Design Austria GmbH, Graz (AT)

(21) Appl. No.: 19/182,961

(22) Filed: Apr. 18, 2025

(51) Int. Cl. H04W 12/0471; H04W 12/037; H04W 12/47

(52) U.S. Cl. CPC H04W 12/0471; H04W 12/037; H04W 12/47

(57) ABSTRACT

A method and a system of exchanging data between a first wireless device and a second wireless device are presented. The method includes obtaining with the first wireless device, an encryption key from the second device; generating, with the first wireless device, encrypted data using the encryption key; broadcasting the encrypted data with the first wireless device; monitoring broadcasted data with the second wireless device; and upon receipt of broadcasted data, checking with the second wireless device if the received data contains encrypted data encrypted using the encryption key; and if so, decrypting the encrypted data.

### TECHNICAL FIELD

The present disclosure relates to a system and method of exchanging data between a first wireless device and a second wireless device. In particular, the disclosure relates to the secure exchange of data between two wireless devices.

### BACKGROUND

A security credential is a form of digital identification that verifies a user's identity or grants access to a system, network, or protected resource. Security credentials authenticate that a person is who they claim to be and determine what they are authorized to access.

A password is one type of security credential. Traditionally passwords were used wherein knowledge of the password translated to an authorization by the password-protected system to the password-knowing user to make use of the system (or a subset of the system, if a user hierarchy is defined).

Bluetooth low energy (BLE) advertising is a communication method used in bluetooth low energy where a device broadcasts data packets over specific radio channels without needing a direct connection to another device. It allows bluetooth low energy-enabled devices to discover each other and exchange small amounts of information efficiently.

There are other types of security credentials. Two other types of security credentials are digital certificates and authentication tokens. Either of these can be stored in a mobile device, for example a mobile phone, and be shared on demand with compatible security systems.

One practical example refers to a voting machine that activates and/or confirm execution of the vote only upon receiving a digital certificate confirming the voter's identity, citizenship status, and registration in the voting district, helping prevent voter fraud. Conventionally, digital certificates may be transferred between the two devices over bluetooth low energy after the two devices have paired. If there are multiple bluetooth low energy devices in proximity, pairing might be done with the wrong bluetooth low energy device, hence leading to certificate leak.

Another problem with the process as described above, is that there are increased security requirements: the exchange of information that includes the certificate must be set-up in a way that reduces the likelihood of this certificate being leaked or other information being eavesdropped. Although encrypting the exchanged information can alleviate some of the problems of such an exchange, this can only be applied after the original handshake between the devices is connected and some type of “pairing” between the transmitter and the receiver has taken place.

It is an object of the disclosure to address one or more of the above-mentioned limitations.

### SUMMARY

According to a first aspect of the disclosure, there is provided a method of exchanging data between a first wireless device and a second wireless device, the method comprising:
obtaining with the first wireless device, an encryption key from the second device;
generating, with the first wireless device, encrypted data using the encryption key;
broadcasting the encrypted data with the first wireless device;
monitoring broadcasted data with the second wireless device; and
upon receipt of broadcasted data, checking with the second wireless device if the received data contains encrypted data encrypted using the encryption key; and if so, decrypting the encrypted data.

For instance, the encrypted data may be an encrypted payload and broadcasted data may be a broadcasted packet containing the encrypted payload.

Optionally, the second wireless device is configured to provide the encryption key via a first wireless communication protocol operating at a first frequency, and the first device is configured to broadcast the encrypted data via a second wireless communication protocol operating at a second frequency.

For example, the second wireless device may provide the encryption key actively by sending it to the first wireless device, or passively by making the encryption key available or accessible to the first wireless device.

For instance, the first frequency may be lower than the second frequency. For example, the first wireless communication protocol may be an NFC protocol operating at 13.56 MHz, and the second wireless communication protocol may be a bluetooth low energy protocol operating at 2.4 GHz. The second wireless device may be provided with an NFC reader or with an NFC tag.

Optionally, the first wireless communication protocol has a shorter communication range than the second wireless communication protocol.

Optionally, the first wireless communication protocol is configured to operate in a first mode for transmitting data actively to another device, and a second mode for making data available to other devices. The first mode may be referred to as active mode and the second mode as passive mode.

Optionally, the first wireless communication protocol is a near-field communication (NFC) protocol.

Optionally, the second wireless communication protocol is a Bluetooth communication protocol or a Zigbee communication protocol or a Wi-Fi communication protocol. For instance, the Bluetooth communication protocol may be Bluetooth Low Energy (BLE).

Optionally, the second wireless device is configured to disable one or more of its functionalities, and upon receiving the encrypted data from the first wireless device, the second wireless device is configured to search for an electronic credential in the encrypted data, and to enable the one or more functionalities if the electronic credential satisfies a predefined set of requirements.

For instance, the electronic credential may be a digital certificate.

Optionally, the second wireless device is configured to read the decrypted data and to perform one or more actions in response.

Optionally, the one or more actions comprise, generating response data; and broadcasting the response data.

Optionally, the second wireless device is configured to send the encryption key to the first wireless device when the first and second wireless devices are within a predetermined distance from each other; or wherein the first wireless device retrieves the encryption key from the second wireless device.

For instance, the first wireless device may obtain the encryption key from the second device by scanning a QR code on the second wireless device.

Optionally, the first wireless device receives an identifier from the second wireless device. For instance, the identifier may be a universally unique identifier (UUID). The first wireless device may be configured to verify the identifier to accept or reject data received from the second device.

According to a second aspect of the disclosure, there is provided a system comprising a first wireless device and a second wireless device, wherein the first wireless device is configured
to obtain an encryption key from the second wireless device;
to generate encrypted data using the encryption key;
to broadcast the encrypted data;
   and wherein the second wireless device is configured to monitor broadcasted data; and upon receipt of broadcasted data, check if the received data contains encrypted data encrypted using the encryption key; and if so, to decrypt the encrypted data.

For instance, the first wireless device may be a user device.

Optionally, the first wireless device is a mobile phone or a fob or a cryptocurrency wallet.

Optionally, the second wireless device is a mobile phone, or a device having restricted access and/or one or more restricted functionalities.

For instance, access to the device or to one or more of its functionalities may be obtained by providing a digital credential such as a digital certificate.

Optionally, the second wireless device is a medication dispenser or an e-cigarette or a voting machine, or a scientific equipment or an industrial device, or a smart lock, or a payment terminal, to name a few. For instance, the payment terminal may be a receiver crypto wallet.

According to a third aspect of the disclosure, there is provided a first wireless device comprising a processor coupled to a communication interface, the first wireless device being configured
to obtain via the communication interface, an encryption key from a second wireless device;
to generate, with the processor, encrypted data using the encryption key; and to broadcast the encrypted data using the communication interface.

Optionally, the first wireless device is configured to obtain the encryption key using a first wireless communication protocol operating at a first frequency; and the first wireless device is further configured to broadcast the encrypted data using a second wireless communication protocol operating at a second frequency.

According to a fourth aspect of the disclosure, there is provided a second wireless device comprising a processor coupled to a communication interface, the second wireless device being configured
to send an encryption key to a first wireless device and/or to make the encryption key available to the first wireless device, using the communication interface;
to monitor for broadcasted data using the communication interface; and wherein the processor is configured to check upon receipt of the broadcasted data, that the received data contains encrypted data encrypted using the encryption key; and if so, to decrypt the encrypted data.

Optionally, the second wireless device is configured to provide the encryption key using a first wireless communication protocol operating at a first frequency; and to monitor for broadcasted data using a second wireless communication protocol operating at a second frequency.

### DESCRIPTION OF THE DRAWINGS

The disclosure is described in further detail below by way of example and with reference to the accompanying drawings, in which:

FIG. 1 is a flow chart of method for exchanging data between a first wireless device and a second wireless device according to the disclosure;

FIG. 2 is a schematic diagram of a system for implementing the method of FIG. 1;

FIG. 3 is a diagram illustrating an exemplary operation between two wireless devices as shown in FIG. 2;

FIG. 4A is flow chart of the steps taken by the first wireless device in the example of FIG. 3;

FIG. 4B is flow chart of the steps taken by the second wireless device in the example of FIG. 3;

FIG. 5A is a sequence diagram illustrating an example operation of the first wireless device as shown in FIG. 2;

FIG. 5B is another sequence diagram illustrating an example operation of the first wireless device; and

FIG. 6 is a sequence diagram illustrating an example operation of the second wireless device as shown in FIG. 2.

### DESCRIPTION

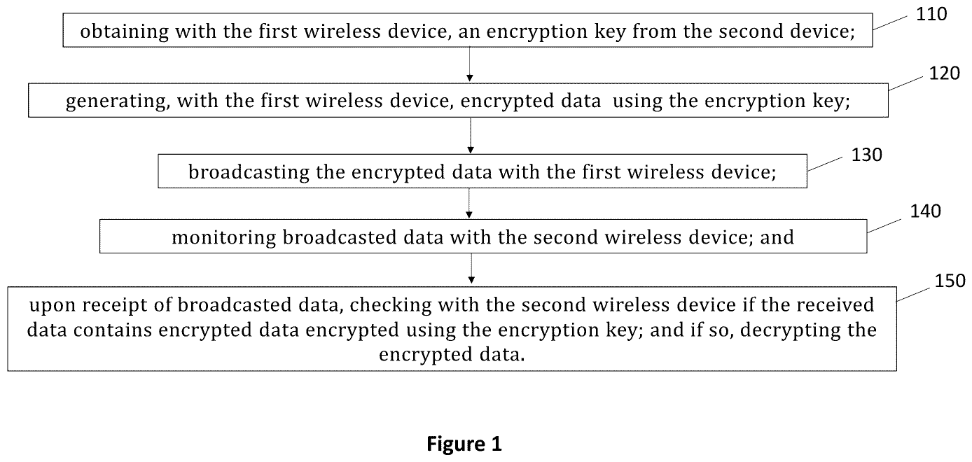

FIG. 1 is a flow chart of method for exchanging data between a first wireless device and a second wireless device. The method includes the following steps:

At step 110, the first wireless device obtains an encryption key from the second wireless device. For instance, the encryption key may be a cryptographic key. The key may be a piece of information, usually a string of numbers or letters that are stored in a file, which, when processed through a cryptographic algorithm, can encode or decode cryptographic data.

In some applications multiple encryption keys may be obtained. In addition, the first wireless device may also obtain an identifier from the second wireless device, such as a universally unique identifier UUID.

At step 120, the first wireless device generates encrypted data using the encryption key. For instance, the encrypted data may be an encrypted payload.

At step 130, the first wireless device broadcasts the encrypted data. For instance, the broadcasted data may be a broadcasted packet containing the encrypted payload. Broadcasting may be performed via different methods, for instance using bluetooth low energy Advertising.

At step 140, the second wireless device monitors broadcasted data.

At step 150, upon receipt of broadcasted data, the second wireless device checks if the received data contains encrypted data encrypted using the encryption key; and if so, decrypts the encrypted data.

The second wireless device may use different techniques for decrypting the data. When symmetric cryptography is implemented, the same key is used for both encryption and decryption. When asymmetric cryptography is implemented, separate keys are used for encrypting and decrypting. These keys may be referred to as the public and private keys, respectively.

The method of FIG. 1 enables broadcasting data securely between two wireless devices without having to establish wireless pairing between the two devices. This reduces potential security vulnerabilities and increases privacy.

In an exemplary implementation the second wireless device provides the encryption key to the first wireless device via a first wireless communication protocol operating at a first frequency, and the first wireless device broadcasts the encrypted data via a second wireless communication protocol operating at a second frequency. For instance, the first wireless communication protocol may have shorter communication range than the second wireless communication protocol. In this way the short range wireless protocol enables the first device to identify the second wireless device, and a secure communication link can be established between the first and second wireless devices via the longer range wireless protocol.

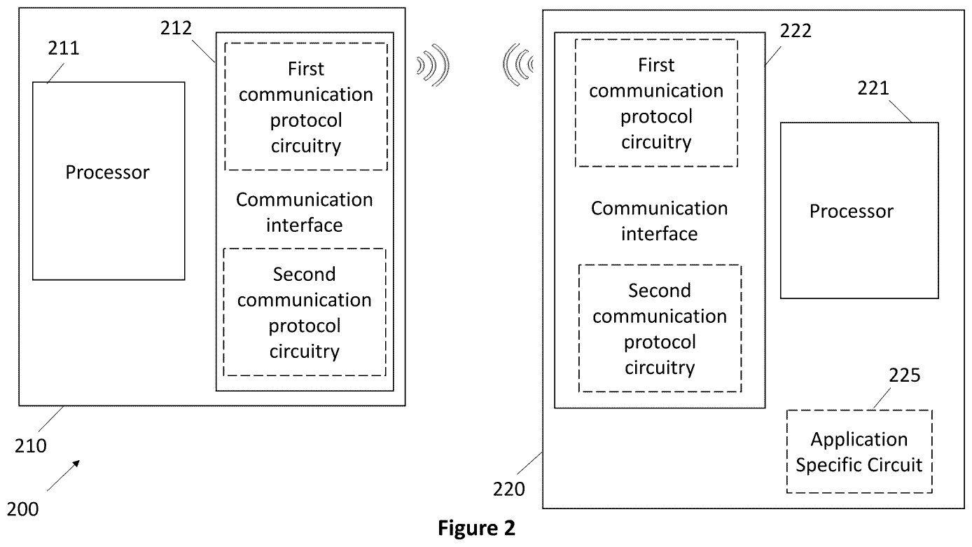

FIG. 2 is a schematic diagram of a system for implementing the method of FIG. 1. The system 200 includes a first wireless device 210 and a second wireless device 220.

The first wireless device 210 has a processor 211 coupled to a communication interface 212. A controller (not shown) is provided to control the communication interface. The controller may be implemented within the communication interface 212 or outside of the communication interface. The first wireless device 210 is configured to obtain, via the communication interface 212, an encryption key from the second wireless device 220. The processor 211 is configured to generate encrypted data using the encryption key and to broadcast the encrypted data using the communication interface 212.

The second wireless device 220 has a processor 221 coupled to a communication interface 222. The controller (not shown) is provided to control the communication interface. The controller may be implemented within the communication interface 222 or outside of the communication interface. The second wireless device 220 is configured to send an encryption key to a first wireless device 210 and/or to make the encryption key available to the first wireless device, using the communication interface 222. The second wireless device 220 is also configured to monitor for broadcasted data using the communication interface 222. The processor 221 is configured to check upon receipt of the broadcasted data, that the received data contains encrypted data encrypted using the encryption key; and if so, to decrypt the encrypted data.

The second wireless device 220 may also be configured to disable one or more of its functionalities. For instance, the device 220 may include one or more application-specific circuit 225 for providing a specific functionality. The processor 221 may be configured to generate control signals to enable or disable the application-specific circuit 225. For instance, if the second wireless device is a medical dispenser for dispensing medication included in a drawer, the control signal may be used to lock or unlock the drawer. If the second wireless device is an e-cigarette, the control signal may be used to activate or de-activate a heating circuit of the e-cigarette. The processor 221 may also be configured to perform various functionalities. Some of these functionalities can also be enabled or disabled by the processor. It will be appreciated that many other examples could be envisaged.

Upon receipt of the encrypted data from the first wireless device 210, the second wireless device 220 then search for an electronic credential in the encrypted data. If the electronic credential satisfies a predefined set of requirements, the second wireless device then enables one or more of its functionalities. This can be achieved by sending an enable signal to the application-specific circuit 225.

For instance, the electronic credential may be a digital certificate or any message, wireless transmission, communication packet or other information transfer allowing to identify the user and/or to check relevant credentials of the user. So the nature of the data included in the electronic credential may vary depending on the application.

The communication interfaces 212 and 222 of the first and second devices, may be adapted to receive and send data using a single communication protocol.

Alternatively, the communication interfaces 212 and 222 may be adapted to receive and send data using a plurality of communication protocols. For instance, first wireless communication protocol operating at a first frequency; and a second wireless communication protocol operating at a second frequency. In this case, the first wireless device 210 may obtain the encryption key using the first wireless communication protocol and broadcast the encrypted data using the second wireless communication protocol. Similarly, the second wireless device may provide the encryption key using the first wireless communication protocol and monitor for broadcasted data using the second wireless communication protocol.

Therefore, in FIG. 2, the communication interface 212 of the first wireless device, and the communication interface 222 of the second wireless device may be provided with a first communication protocol circuitry and a second communication protocol circuitry.

The first wireless communication protocol may be a near-field communication (NFC) protocol. The second wireless communication protocol may be a Bluetooth communication protocol such as bluetooth low energy (BLE) or a Zigbee communication protocol or a Wi-Fi communication protocol, to name a few.

So in a specific example, the first communication protocol circuitry is an NFC circuitry, and the second communication protocol circuitry is a bluetooth low energy circuitry. The NFC circuitry may include and NFC reader/writer, and/or an NFC tag, and an NFC controller. The NFC controller may be implemented as part of the communication interface or outside of the communication interface. The NFC tag may an NDEF tag, hence a tag that uses NFC Data Exchange Format (NDEF) to store data. NDEF is a standardized way to encode data onto NFC tags, and to exchange data between NFC devices.

The Bluetooth low energy circuitry may include a bluetooth low energy transceiver and a bluetooth low energy controller. The bluetooth low energy controller may be implemented as part of the communication interface or outside of the communication interface. The bluetooth low energy controller and the NFC controller may also be implemented as a single (combined) controller. It will be appreciated that the components shown in FIG. 2 may be implemented as discrete components or integrated, for instance in a single chip (integrated circuit).

Depending on the application, the first and second wireless devices may be implemented in various ways. For instance, the first wireless device 210 may be a user device such as a mobile phone, or a fob (for example, a car fob) or a cryptocurrency wallet. The first wireless device 210 may also be provided with circuitry that enable authenticating the user via biometric authentication or any other type of authentication. The first wireless device 210 may be a portable or a wearable device. In another example, the first wireless device 210 could be implemented as cryptocurrency wallet arranged to communicate with other similar wallets or other type of electronic devices to perform financial transactions or crypto payments.

The second wireless device 220 may be another user device such as a mobile phone, or a device having restricted access and/or one or more restricted functionalities restricted to only authorized users.

For example, the second wireless device 220 may be a medication dispenser, that may be unlocked only by a health professional to refill it with medicines, or to enable additional doses.

In another example, the second wireless device 220 may be an e-cigarette or vape whose functionality is restricted only to users that can prove they are authorized. For instance, the owner of the device may be authenticated.

In another example, the second wireless device 220 may be a portable safe that remains unlocked unless the user authenticates himself.

In another example, the second wireless device 220 may be a voting machine that activates and/or confirm execution of the vote only upon receiving a digital certificate confirming the voter's identity, citizenship status, and registration in the voting district, helping prevent voter fraud.

In another example, the second wireless device 220 may be a scientific or medical equipment that handles dangerous materials and only operates when receiving a digital certificate confirming the user has proper training, clearance level, and authorization to operate the equipment. Alternatively, the medical equipment may be a temperature cooled organ container with secure access.

In another example, the second wireless device 220 may be a receiver crypto wallet that receives from another crypto wallet (i.e. the first wireless device), via NFC, the receiver wallet address, thus enabling the first device to sign a transaction and agree to transfer payment.

In another example, the second wireless device 220 may be a vehicle, or a device within the vehicle, that activates the engine only when receiving a digital certificate that proves the identity of the driver.

In another example, the second wireless device 220 may be a power tool. The user could get a certificate to activate the power tool at purchase or for a certain period of time, for instance according to a rental contract.

Both the first and the second wireless devices may be portable devices, however this is not a requirement. One or both devices may be a wearable device, for example a smart watch or a smart ring.

The system 200 enables secure exchange of information, even for resource-constrained devices.

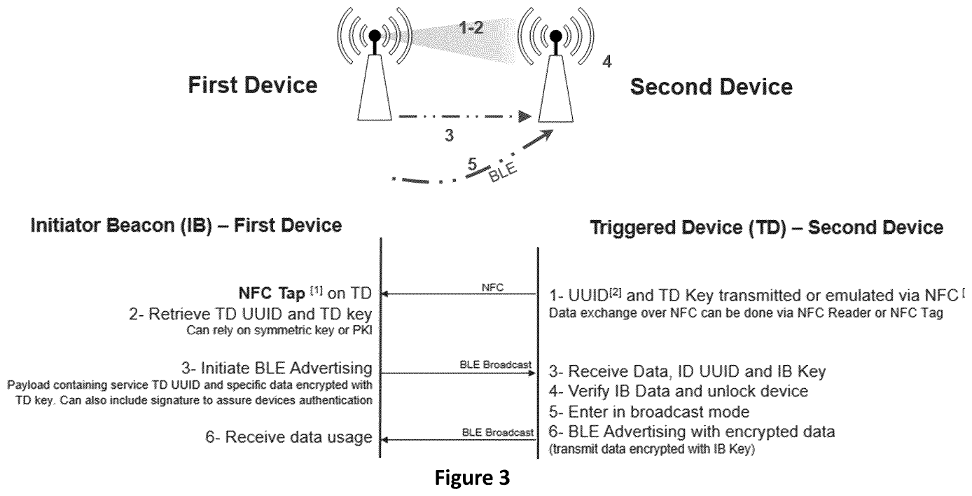

FIG. 3 is a diagram illustrating an exemplary operation between two wireless devices as shown in FIG. 2. The first wireless device is referred to as the Initiator Beacon, IB and the second wireless device is referred to as the Triggered Device, TD. In this example both devices are NFC-enabled. The TD is provided with a set of restricted functionalities, for instances circuits that may be enable or disabled depending on user credentials. The TD is also provided with an NDEF tag.

The IB device is positioned in proximity to the TD device. When the distance between the two devices is close enough an NFC tap is initiated. In response to the NFC tap, the TD provides to the IB device a predefined set of information via the NDEF tag. This information may include for example a device key for TD and an encryption key, for example a Public Key Infrastructure PKI key. Alternatively, or additionally, other types of encryption key may be transmitted to the IB, for example a symmetric key. The encryption key or keys may be cryptographic key(s).

In response to receiving from the TD the encryption key, the IB uses the received encryption key to encrypt data, for instance a message or request, to be sent to the TD. The encrypted data may contain a digital certificate maintained on the IB. In this example, the digital certificate may be a digital identity verification certificate.

The IB then starts broadcasting the encrypted data (for instance via bluetooth low energy advertising). The broadcasted encrypted data may be received by a third device. If the third device does not possess the necessary cryptographic keys, it cannot decrypt the data. Depending on how the third device is configured, in response to detecting that the referenced UUID does not correspond to its own ID the third device may discard the received encrypted data.

The TD being in possession of the encryption key or any key allowing the decryption of the encrypted data, can recover the digital certificate in the broadcasted encrypted data. For instance, the key may be a decryption key, or a private key. For example, a Private Key Infrastructure (PKI) uses asymmetric encryption to secure digital communications within an organization. Having recovered the digital certificate, the TD can confirm the contents of the digital certificate and enable its restricted functionality.

The step of enabling restricted functionality may vary depending on the application. For instance, it could include unlocking one or more containers of a smart dispenser's containers to allow access to their contents. It may also include establishing a bluetooth low energy connection with the IB for further data exchange between IB and TD.

Therefore, data is included in the bluetooth low energy broadcasts, that is only retrievable by a selected device. The two devices IB and TD can exchange data securely via bluetooth low energy while avoiding bluetooth low energy Pairing. Avoiding bluetooth low energy Pairing reduces the attack surface (the sum of the different points where an attacker may try to interfere with the device) of the two-device-link, hence lowering attack vectors and improving privacy. As such, the proposed approach enables enhanced privacy and reduces the potential security vulnerabilities of direct bluetooth low energy connection.

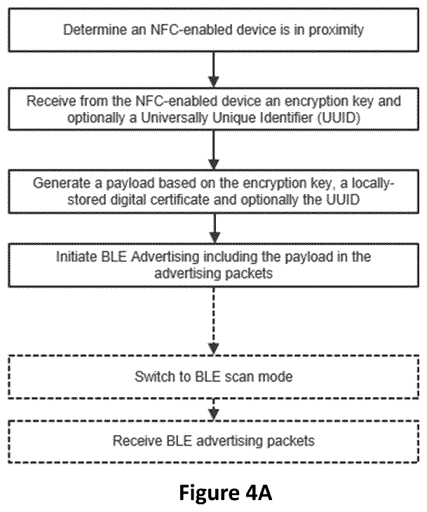

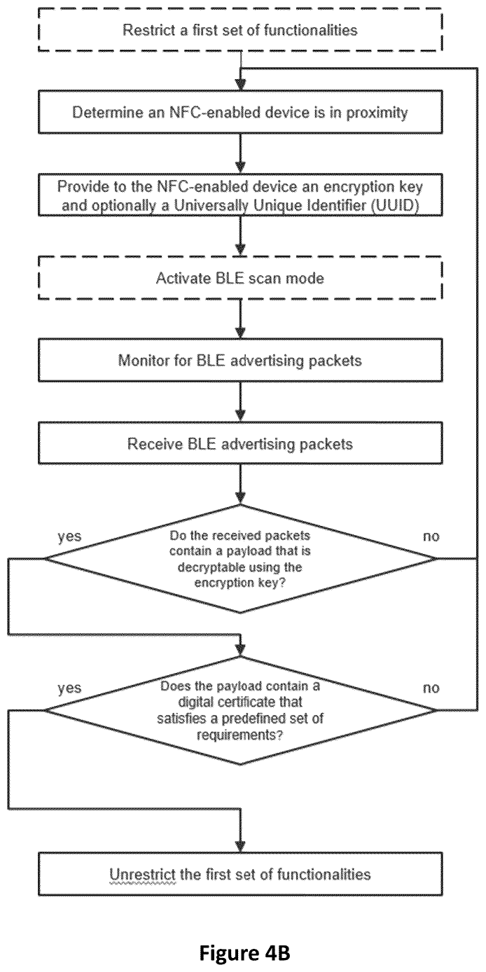

FIG. 4A is flow chart of the steps taken by the first wireless device in the example of FIG. 3.

FIG. 4B is flow chart of the steps taken by the second wireless device in the example of FIG. 3.

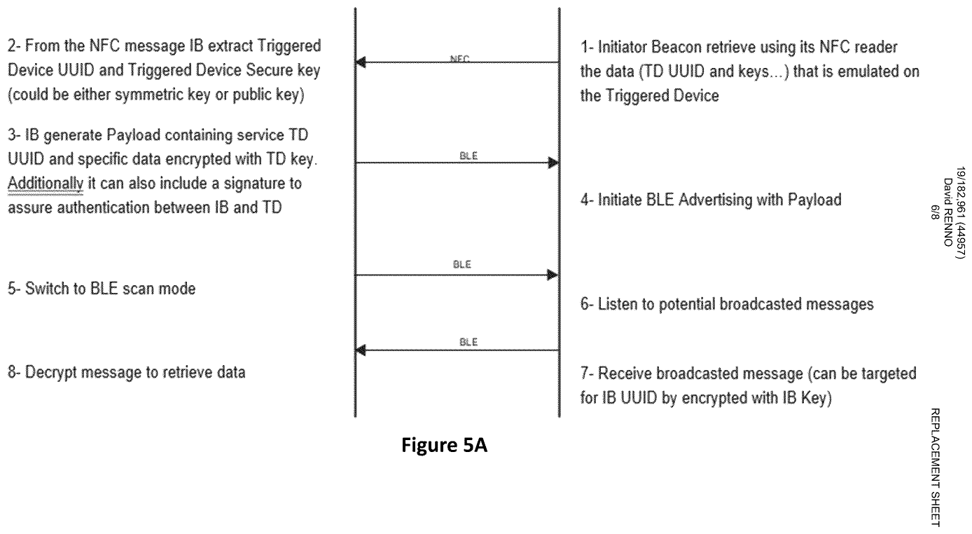

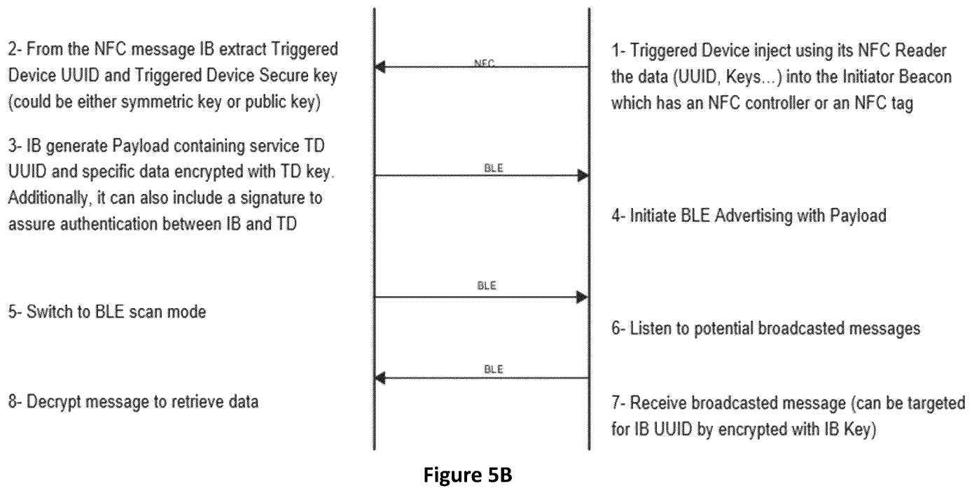

FIG. 5A is a sequence diagram illustrating an example operation of the first wireless device. The diagram shows 8 steps. The steps 1, 4, 6 and 7 occur at the communication interface of the first wireless device. The steps 2, 3, 5 and 8 are performed by the processor and/or controller of the first wireless device in connection with its communication interface.

In this example at step 1, the IB retrieves the encryption key from the TD using its NFC reader by reading the encryption key made available by the TD to the IB.

At step 2, the IB processor extracts the TD identifier and encryption key, and then generates an encrypted payload encrypted with the TD encryption key. Optionally, the processor may also include an electronic credential such as a signature or a digital certificate to assure authentication between IB and TD.

At step 4, the communication interface initiates the broadcast of the encrypted payload, in this example using bluetooth low energy advertising.

At steps 5 and 6 the controller switches the bluetooth low energy scan mode so that the communication interface starts listening for potential broadcast from other devices.

At step 7 the communication interface receives broadcasted data/message.

At step 8 the processor attempts to decrypt the data. If the data is encrypted with a key available to IB, then the data/message can be decrypted.

FIG. 5B is another sequence diagram illustrating an example operation of the first wireless device. This sequence is similar to the sequence of FIG. 5A, apart from step 1.

In this example, at the step 1, the IB device receives the encryption key directly from TD. The TD sends the encryption key using its NFC reader to the NFC tag of the IB.

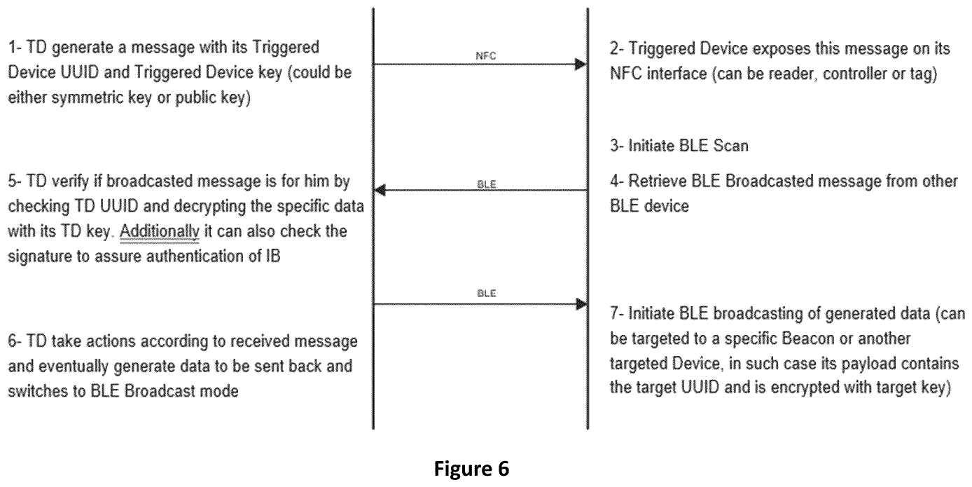

FIG. 6 is a sequence diagram illustrating an example operation of the second wireless device. The diagram shows 7 steps. The steps 2, 3, 4 and 7 occur at the communication interface of the second device. The steps 1, 5 and 6 are performed by the processor and/or controller of the second wireless device in connection with its communication interface.

At step 1, the TD processor generates an encryption key.

At step 2, the TD communication interface makes the key available on its NFC interface to the IB device.

At steps 3 and 4, bluetooth low energy scan is initiated and broadcasted data/messages are retrieved from other bluetooth low energy devices.

At step 5, the TD processor attempts to decrypt the data received with its TD key. Additionally, the TD processor may also check for the presence of an electronic credential such as a signature or a digital certificate to assure authentication of IB.

At step 6 the TD processor initiates one or more actions in response to the decrypted data/message. This may include generating response data to be sent back. The bluetooth low energy controller may initiate bluetooth low energy broadcasting.

At step 7, the communication interface broadcast the response data.

In the above examples, the original exchange of information happens via an NFC tap. However, in alternative implementations the NFC tap may be replaced by alternative means. For example, the TD may bear a QR code and the IB may scan the QR code to obtain the encryption key.

It will also be appreciated that the method of FIG. 1 can be extended to more than two wireless devices. For instance, the first wireless device (IB) may exchange data with more than one triggered device (TD), for example with a second wireless device and a third wireless device, in the same fashion.

A skilled person will therefore appreciate that variations of the disclosed arrangements are possible without departing from the disclosure. Accordingly, the above description of the specific embodiments is made by way of example only and not for the purposes of limitation. It will be clear to the skilled person that minor modifications may be made without significant changes to the operation described.

1. A method of exchanging data between a first wireless device and a second wireless device, the method comprising:
obtaining with the first wireless device, an encryption key from the second device;
generating, with the first wireless device, encrypted data using the encryption key;
broadcasting the encrypted data with the first wireless device;
monitoring broadcasted data with the second wireless device; and
upon receipt of broadcasted data, checking with the second wireless device if the received data contains encrypted data encrypted using the encryption key; and if so, decrypting the encrypted data.

2. The method as claimed in claim 1, wherein the second wireless device is configured to provide the encryption key via a first wireless communication protocol operating at a first frequency, and wherein the first device is configured to broadcast the encrypted data via a second wireless communication protocol operating at a second frequency.

3. The method as claimed in claim 2, wherein the first wireless communication protocol has a shorter communication range than the second wireless communication protocol.

4. The method as claimed in claim 2, wherein the first wireless communication protocol is configured to operate in a first mode for transmitting data actively to another device, and a second mode for making data available to other devices.

5. The method as claimed in claim 2, wherein the first wireless communication protocol is a near-field communication (NFC) protocol.

6. The method as claimed in claim 2, wherein the second wireless communication protocol is a Bluetooth communication protocol or a Zigbee communication protocol or a Wi-Fi communication protocol.

7. The method as claimed in claim 1, wherein the second wireless device is configured to disable one or more of its functionalities, and wherein upon receiving the encrypted data from the first wireless device, the second wireless device is configured to search for an electronic credential in the encrypted data, and to enable the one or more functionalities if the electronic credential satisfies a predefined set of requirements.

8. The method as claimed in claim 1, wherein the second wireless device is configured to read the decrypted data and to perform one or more actions in response.

9. The method as claimed in claim 8, wherein the one or more actions comprise, generating response data; and broadcasting the response data.

10. The method as claimed in claim 1, wherein the second wireless device is configured to send the encryption key to the first wireless device when the first and second wireless devices are within a predetermined distance from each other; or wherein the first wireless device retrieves the encryption key from the second wireless device.

11. The method as claimed in claim 1, wherein the first wireless device receives an identifier from the second wireless device.

12. A system comprising a first wireless device and a second wireless device, wherein the first wireless device is configured to:
obtain an encryption key from the second wireless device;
generate encrypted data using the encryption key; and
broadcast the encrypted data;
wherein the second wireless device is configured to monitor broadcasted data; and upon receipt of broadcasted data, check if the received data contains encrypted data encrypted using the encryption key; and if so, to decrypt the encrypted data.

13. The system as claimed in claim 12, wherein the first wireless device is a mobile phone or a fob or a cryptocurrency wallet.

14. The system as claimed in claim 12, wherein the second wireless device is a mobile phone, or a device having restricted access and/or one or more restricted functionalities.

15. The system as claimed in claim 12, wherein the device having restricted access is a medication dispenser or an e-cigarette or a voting machine, or a scientific equipment, or a payment terminal.

16. A first wireless device comprising a processor coupled to a communication interface, the first wireless device being configured to:
obtain via the communication interface, an encryption key from a second wireless device;
generate, with the processor, encrypted data using the encryption key; and
broadcast the encrypted data using the communication interface.

17. The first wireless device as claimed in claim 16, configured to obtain the encryption key using a first wireless communication protocol operating at a first frequency; and
wherein the first wireless device is further configured to broadcast the encrypted data using a second wireless communication protocol operating at a second frequency.

18. A second wireless device comprising a processor coupled to a communication interface, the second wireless device being configured to:
send an encryption key to a first wireless device and/or to make the encryption key available to the first wireless device, using the communication interface; and
monitor for broadcasted data using the communication interface;
wherein the processor is configured to check upon receipt of the broadcasted data, that the received data contains encrypted data encrypted using the encryption key; and if so, to decrypt the encrypted data.

19. The second wireless device as claimed in claim 18, configured to provide the encryption key using a first wireless communication protocol operating at a first frequency; and to monitor for broadcasted data using a second wireless communication protocol operating at a second frequency.
